(19) United States
(12) Patent Application Publication
(10) Pub. No.: US 2007/0209541 A1
(43) Pub. Date: Sep. 13, 2007

(54) Stability display method and stability display apparatus

(75) Inventors: Satoru Kiyohara, Kyoto (JP); Kazuki Fukui, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG.CO.,LTD.

(21) Appl. No.: 11/712,471

(22) Filed: Mar. 1, 2007

(30) Foreign Application Priority Data
Mar. 2, 2006 (JP) 2006-056400

(51) Int. Cl. B41F 33/00

(52) U.S. Cl. 101/484

(57) ABSTRACT

The disclosed method and apparatus execute a printing step for setting a printing condition concerning at least one of a printing machine, a dot pattern, printing paper and ink, and printing an image having a plurality of different dot percentages with the printing condition set; a profile creating step for creating a profile showing printing stability in form of a relationship between the printing condition and each of the dot percentages by measuring a print image obtained in the printing step; a calculating step for deriving printing stability for each color area of an image to be printed, from image data of the image to be printed, the printing condition in time of printing and the profile; and a displaying step for displaying the printing stability of each color area, obtained in the calculating step, of the image to be printed.

### BACKGROUND OF THE INVENTION

1. Field of the Invention

This invention relates to a stability display method and a stability display apparatus for displaying a degree of printing stability for each color area of an image to be printed.

2. Description of the Related Art

A known printing simulation apparatus is described in Japanese Unexamined Patent Publication H4-261856 (1992), for example. The apparatus described in this publication creates a look-up table by measuring data according to the type of paper and the type of ink, and can display simulations of actually printed images by using this look-up table.

However, the stability of color is not taken into consideration for the apparatus described in the above publication. The printing stability discussed herein refers to a characteristic as to whether proper color tones of prints are easily securable or not. For example, printing stability is considered high when an adjustment is carried out easily to obtain desired tones from an actual printing operation, and low when such an adjustment is difficult. A low degree of printing stability causes the problems of increasing the incidence of spoilage, and wasting printing materials and working hours for color tone adjustment. It is therefore impossible, in a prepress stage or the like preceding a printing stage, to determine what type of image is difficult to print properly. Thus, although what is required in the prepress stage is only to change the type of halftone dot, for example, there arises a troublesome situation of having to adjust color tones and the like in order to obtain proper prints in the printing stage.

### SUMMARY OF THE INVENTION

The object of this invention, therefore, is to provide a stability display method and a stability display apparatus for allowing the stability of color to be determined in a stage prior to printing, thereby easily realizing proper prints.

The above object is fulfilled, according to this invention, by a stability display method comprising a printing step for setting a printing condition concerning at least one of a printing machine, a dot pattern, printing paper and ink, and printing an image having a plurality of different dot percentages with the printing condition set; a profile creating step for creating a profile showing a degree of printing stability in form of a relationship between the printing condition and each of the dot percentages by measuring a print image obtained in the printing step; a calculating step for deriving a degree of printing stability for each color area of an image to be printed, from image data of the image to be printed, the printing condition in time of printing and the profile; and a displaying step for displaying the degree of printing stability of each color area, obtained in the calculating step, of the image to be printed.

In another aspect of the invention, a stability display apparatus comprises a profile storage device for setting a printing condition concerning at least one of a printing machine, a dot pattern, printing paper and ink, and storing a profile showing a degree of printing stability determined in form of a relationship between the printing condition and each dot percentage by measuring an image with the printing condition set and having a plurality of different dot percentages; a calculating device for deriving a degree of printing stability for each color area of an image to be printed, from image data of the image to be printed, the printing condition in time of printing and the profile stored in the profile storage device; and a display device for displaying the degree of printing stability of each color area, calculated by the calculating device, of the image to be printed.

Other features and advantages of the invention will be apparent from the following detailed description of the embodiments of the invention.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a schematic view of a printing machine to which this invention is applied;

FIG. 2 is a schematic side view showing an imaging unit along with a paper discharge mechanism such as a paper discharge cylinder;

FIG. 3 is a block diagram of a principal electrical structure of the printing machine;

FIG. 4 is a flow chart of a profile creating process;

FIG. 5 is a flow chart of stability calculating and display processes;

FIG. 6 is a schematic view showing a display screen of a control panel;

FIG. 7A is a schematic view showing a display of stability on the display screen of the control panel; and

FIG. 7B is a schematic view showing another display of stability on the display screen of the control panel.

### DESCRIPTION OF THE PREFERRED EMBODIMENTS

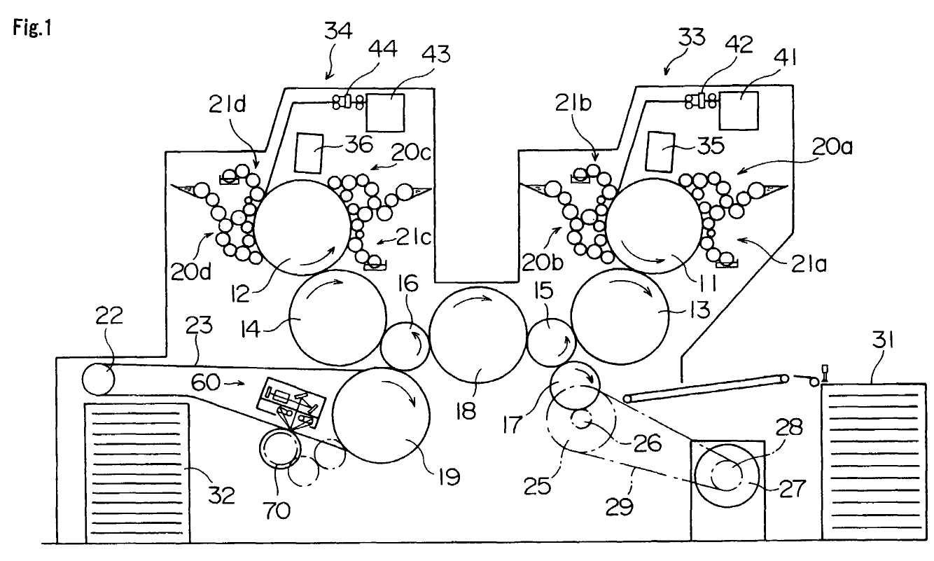

An embodiment of this invention will be described hereinafter with reference to the drawings. The construction of a printing machine to which the stability display method of this invention is applied will be described first. FIG. 1 is a schematic view of the printing machine according to this invention.

This printing machine records images on blank plates mounted on first and second plate cylinders 11 and 12 in a prepress process, feeds inks to the plates having the images recorded thereon, and transfers the inks from the plates through first and second blanket cylinders 13 and 14 to printing paper held on first and second impression cylinders 15 and 16, thereby printing the images in four colors on the printing paper.

The printing machine has the first plate cylinder 11, the second plate cylinder 12, the first blanket cylinder 13 contactable with the first plate cylinder 11, the second blanket cylinder 14 contactable with the second plate cylinder 12, the first impression cylinder 15 contactable with the first blanket cylinder 13, and the second impression cylinder 16 contactable with the second blanket cylinder 14. The printing machine further includes a paper feed cylinder 17 for transferring printing paper supplied from a paper storage station 31 to the first impression cylinder 15, a transfer cylinder 18 for transferring the printing paper from the first impression cylinder 15 to the second impression cylinder 16, a paper discharge cylinder 19 with chains 23 wound thereon and extending to and wound on sprockets 22 for discharging printed paper from the second impression cylinder 16 to a paper discharge station 32, and an imaging unit 60 for reading images printed on the printing paper.

Each of the first and second plate cylinders 11 and 12 is what is called a two-segmented cylinder for holding two printing plates peripherally thereof for printing in two different colors. The first and second blanket cylinders 13 and 14 have the same diameter as the first and second plate cylinders 11 and 12, and each has blanket surfaces for transferring images in two colors.

The first and second impression cylinders 15 and 16 movable into contact with the first and second blanket cylinders 13 and 14, respectively, have half the diameter of the first and second plate cylinders 11 and 12 and the first and second blanket cylinders 13 and 14. The first and second impression cylinders 15 and 16 have grippers, not shown, for holding and transporting the forward end of printing paper.

The paper feed cylinder 17 disposed adjacent the impression cylinder 15 has the same diameter as the first and second impression cylinders 15 and 16. The paper feed cylinder 17 has a gripper, not shown, for holding and transporting, with each intermittent rotation of the feed cylinder 17, the forward end of each sheet of printing paper fed from the paper storage station 31. When the printing paper is transferred from the feed cylinder 17 to the first impression cylinder 15, the gripper of the first impression cylinder 15 holds the forward end of the printing paper which has been held by the gripper of the feed cylinder 17.

The transfer cylinder 18 disposed between the first impression cylinder 15 and second impression cylinder 16 has the same diameter as the first and second plate cylinders 11 and 12 and the first and second blanket cylinders 13 and 14. The transfer cylinder 18 has a gripper, not shown, for holding and transporting the forward end of the printing paper received from the first impression cylinder 15, and transferring the forward end of the printing paper to the gripper of the second impression cylinder 16.

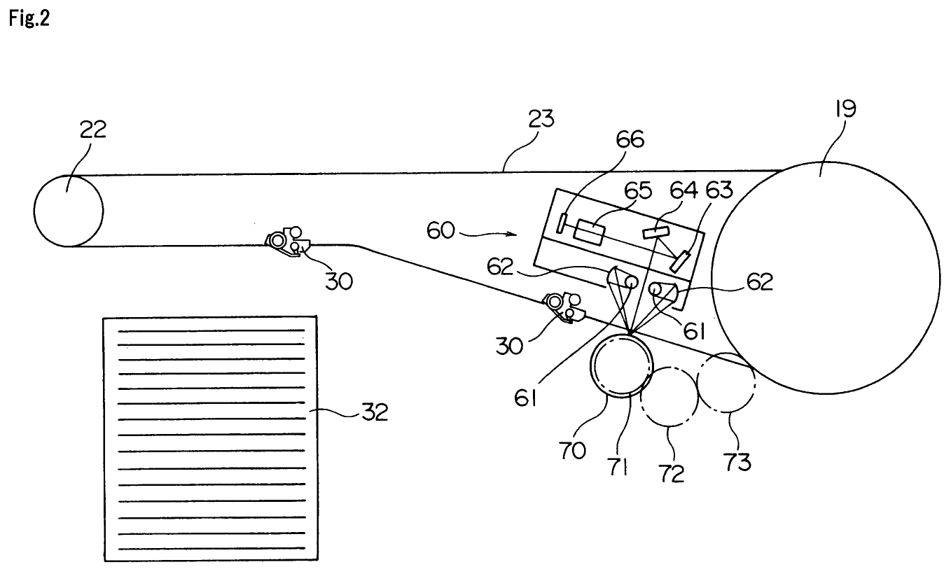

The paper discharge cylinder 19 disposed adjacent the second impression cylinder 16 has the same diameter as the first and second plate cylinders 11 and 12 and the first and second blanket cylinders 13 and 14. The discharge cylinder 19 has a pair of chains 23 wound around opposite ends thereof. The chains 23 are interconnected by coupling members, not shown, having a plurality of grippers 30 arranged thereon (FIG. 2). When the second impression cylinder 16 transfers the printing paper to the discharge cylinder 19, one of the grippers 30 on the discharge cylinder 17 holds the forward end of the printing paper having been held by the gripper of the second impression cylinder 16. With movement of the chains 23, the printing paper is transported to the paper discharge station 32 to be discharged thereon.

The paper feed cylinder 17 has a gear attached to an end thereof and connected to a gear 26 disposed coaxially with a driven pulley 25. A belt 29 is wound around and extends between the driven pulley 25 and a drive pulley 28 rotatable by a motor 27. Thus, the paper feed cylinder 17 is rotatable by drive of the motor 27. The first and second plate cylinders 11 and 12, first and second blanket cylinders 13 and 14, first and second impression cylinders 15 and 16, paper feed cylinder 17, transfer cylinder 18 and paper discharge cylinder 19 are coupled to one another by gears attached to ends thereof, respectively. Thus, by the drive of motor 27, the paper feed cylinder 17, first and second impression cylinders 15 and 16, paper discharge cylinder 19, first and second blanket cylinders 13 and 14, first and second plate cylinders 11 and 12 and transfer cylinder 18 are rotatable synchronously with one another.

The first plate cylinder 11 is surrounded by an ink feeder 20a for feeding an ink of black (K), for example, to a plate, an ink feeder 20b for feeding an ink of cyan (C), for example, to a plate, and dampening water feeders 21a and 21b for feeding dampening water to the plates. The second plate cylinder 12 is surrounded by an ink feeder 20c for feeding an ink of magenta (M), for example, to a plate, an ink feeder 20d for feeding an ink of yellow (Y), for example, to a plate, and dampening water feeders 21c and 21d for feeding dampening water to the plates.

Further, arranged around the first and second plate cylinders 11 and 12 are a plate feeder 33 for feeding plates to the peripheral surface of the first plate cylinder 11, a plate feeder 34 for feeding plates to the peripheral surface of the second plate cylinder 12, an image recorder 35 for recording images on the plates mounted peripherally of the first plate cylinder 11, and an image recorder 36 for recording images on the plates mounted peripherally of the second plate cylinder 12.

FIG. 2 is a schematic side view showing the imaging unit 60 along with a paper discharge mechanism such as the paper discharge cylinder 19.

The imaging unit 60 is used for reading images and measuring densities of printing control scales printed on the printing paper.

The pair of chains 23 are endlessly wound around the opposite ends of the paper discharge cylinder 19 and the pair of sprockets 22. As noted hereinbefore, the chains 23 are interconnected by coupling members, not shown, having a plurality of grippers 30 arranged thereon each for gripping the forward end of printing paper transported. FIG. 2 shows only two grippers 30, with the other grippers 30 omitted.

The pair of chains 23 have a length corresponding to a multiple of the circumference of first and second impression cylinders 15 and 16. The grippers 30 are arranged on the chains 23 at intervals each corresponding to the circumference of first and second impression cylinders 15 and 16. Each gripper 30 is opened and closed by a cam mechanism, not shown, synchronously with the gripper on the paper discharge cylinder 19. Thus, each gripper 30 receives the printing paper from the paper discharge cylinder 19, transports the printing paper with rotation of the chains 23, and is then opened by the cam mechanism, not shown, to discharge the paper on the paper discharge station 32.

The printing paper is transported with only the forward end thereof held by one of the grippers 30, the rear end of printing paper not being fixed. Consequently, the printing paper could flap during transport, which impairs an operation, to be described hereinafter, of the imaging unit 60 to read images and measure densities of printing control scales S. To avoid such an inconvenience, this printing machine provides a suction roller 70 disposed upstream of the paper discharge station 32 for stabilizing the printing paper transported.

The suction roller 70 is in the form of a hollow roller having a surface defining minute suction bores, with the hollow interior thereof connected to a vacuum pump not shown. The suction roller 70 has a gear 71 attached to an end thereof. The gear 71 is connected through idler gears 72 and 73 to the gear attached to an end of the paper discharge cylinder 19. Consequently, the suction roller 70 is driven to rotate in a matching relationship with a moving speed of the grippers 30. Thus, the printing paper is sucked to the surface of the suction roller 70, thereby being held against flapping when passing over the suction roller 70. In place of the suction roller 70, a suction plate may be used to suck the printing paper two-dimensionally.

The above imaging unit 60 includes a pair of linear light sources 61 extending parallel to the suction roller 70 for illuminating the printing paper on the suction roller 70, a pair of condensing plates 62, reflecting mirrors 63 and 64, a condensing lens 65 and a CCD line sensor 66. The printing paper transported by the paper discharge mechanism including the paper discharge cylinder 19 and chains 23 is illuminated by the pair of linear light sources 61, and photographed by the CCD line sensor 66.

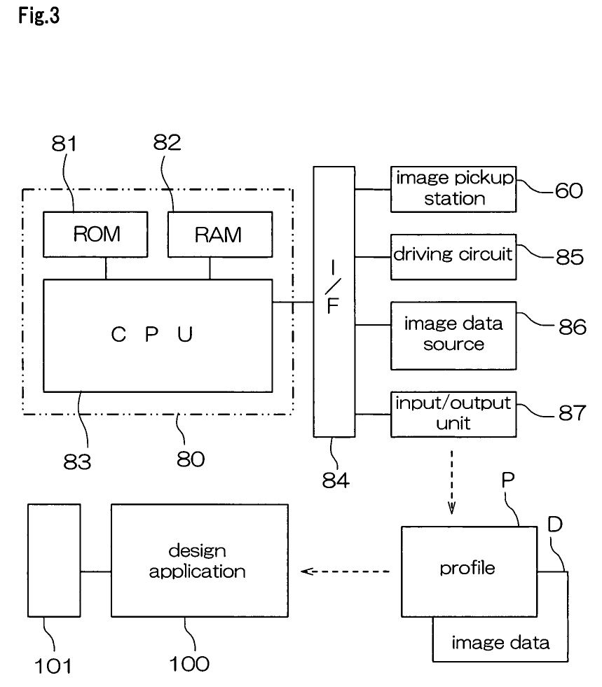

FIG. 3 is a block diagram showing a principal electrical structure of the printing machine along with a design application 100, a profile P and so on.

This printing machine includes a control unit 80 having a ROM 81 for storing operating programs necessary for controlling the machine, a RAM 82 for temporarily storing data and the like during a control operation, and a CPU 83 for performing logic operations. The control unit 80 is connected to the imaging unit 60 through an interface 84. Further, the control unit 80 is connected through the interface 84 to a driving circuit 85 for generating driving signals for driving the ink feeders 20, dampening water feeders 21, image recorders 35 and 36, and so on. The control unit 80 is connected also to an input/output unit 87 having a control panel of the touch panel type using liquid crystal to be capable of inputting data and displaying images. The control unit 80 is connected, through the interface 84, also to an image data source 86 storing the data of images for use in platemaking and printing.

The printing machine is controlled by this control unit 80 to execute a prepress operation, a printing operation including ink and dampening water feeding, and a profile creating operation according to this invention, as described hereinafter. The RAM 82 in the control unit 80 acts as the profile storage device according to this invention.

A profile P created by the control unit 80 and outputted on-line or off-line from the input/output unit 87 is inputted to a design application 100, such as a DTP application used in a prepress stage or the like preceding a printing stage. The profile P refers to a function that, given an image area percentage for each area of a printed image and a state in time of printing (printing conditions), returns a degree of stability expected to occur when printing such each area under the printing conditions. The profile P is created by successively executing a test image printing step, a test data measuring step, a profile calculating step based on image data and measurement data of a test image as described hereinafter. The design application 100 acts as the calculating device according to this invention.

The design application 100 includes a control panel 101 of the touch panel type using liquid crystal. The control panel 101 acts as the display device according to this invention.

In the printing machine having the above construction, a printing plate stock drawn from a supply cassette 41 of the plate feeder 33 is cut to a predetermined size by a cutter 42. The forward end of each plate in cut sheet form is guided by guide rollers and guide members, not shown, and is clamped by clamps of the first plate cylinder 11. Then, the first plate cylinder 11 is driven by a motor, not shown, to rotate at low speed, whereby the plate is wrapped around the peripheral surface of the first plate cylinder 11. The rear end of the plate is clamped by other clamps of the first plate cylinder 11. While, in this state, the first plate cylinder 11 is rotated at high speed, the image recorder 35 irradiates the surface of the plate mounted peripherally of the first plate cylinder 11 with a laser beam modulated according image data, for recording an image thereon.

Similarly, a printing plate stock drawn from a supply cassette 43 of the plate feeder 34 is cut to the predetermined size by a cutter 44. The forward end of each plate in cut sheet form is guided by guide rollers and guide members, not shown, and is clamped by clamps of the second plate cylinder 12. Then, the second plate cylinder 12 is driven by a motor, not shown, to rotate at low speed, whereby the plate is wrapped around the peripheral surface of the second plate cylinder 12. The rear end of the plate is clamped by other clamps of the second plate cylinder 12. While, in this state, the second plate cylinder 12 is rotated at high speed, the image recorder 36 irradiates the surface of the plate mounted peripherally of the second plate cylinder 12 with a laser beam modulated according image data, for recording an image thereon.

The first plate cylinder 11 has, mounted peripherally thereof, a plate for printing in black ink and a plate for printing in cyan ink. The two plates are arranged in evenly separated positions (i.e. in positions separated from each other by 180 degrees). The image recorder 35 records images on these plates. Similarly, the second plate cylinder 12 has, mounted peripherally thereof, a plate for printing in magenta ink and a plate for printing in yellow ink. The two plates also are arranged in evenly separated positions, and the image recorder 36 records images on these plates, to complete a prepress process.

The prepress process is followed by a printing process for printing the printing paper with the plates mounted on the first and second plate cylinders 11 and 12. This printing process is carried out as follows.

First, each dampening water feeder 21 and each ink feeder 20 are placed in contact with only a corresponding one of the plates mounted on the first and second plate cylinders 11 and 12. Consequently, dampening water and inks are fed to the plates from the corresponding water feeders 21 and ink feeders 20, respectively. These inks are transferred from the plates to the corresponding regions of the first and second blanket cylinders 13 and 14, respectively.

Then, the printing paper is fed to the paper feed cylinder 17. The printing paper is subsequently passed from the paper feed cylinder 17 to the first impression cylinder 15. The impression cylinder 15 having received the printing paper continues to rotate. Since the first impression cylinder 15 has half the diameter of the first plate cylinder 11 and the first blanket cylinder 13, the black ink is transferred to the printing paper wrapped around the first impression cylinder 15 in its first rotation, and the cyan ink in its second rotation.

After the first impression cylinder 15 makes two rotations, the printing paper is passed from the first impression cylinder 15 to the second impression cylinder 16 through the transfer cylinder 18. The second impression cylinder 16 having received the printing paper continues to rotate. Since the second impression cylinder 16 has half the diameter of the second plate cylinder 12 and the second blanket cylinder 14, the magenta ink is transferred to the printing paper wrapped around the second impression cylinder 16 in its first rotation, and the yellow ink in its second rotation.

The forward end of the printing paper printed in the four colors in this way is passed from the second impression cylinder 16 to the paper discharge cylinder 19. The printing paper is transported by the pair of chains 23 toward the paper discharge station 32 to be discharged thereon. At this time, the printing paper being transported is illuminated by the pair of linear light sources 61, and is photographed by the CCD line sensor 66.

In the printing process, the image printed on the printing paper is measured by CCD line sensor 66 in the imaging unit 60. The ink feed rates are controlled and color tones adjusted based on color values of representative points in the image.

After the printing process, the printing paper printed is discharged. The first and second blanket cylinders 13 and 14 are cleaned by a blanket cylinder cleaning device, not shown, to complete the printing process.

Next, a stability display operation according to this invention will be described.

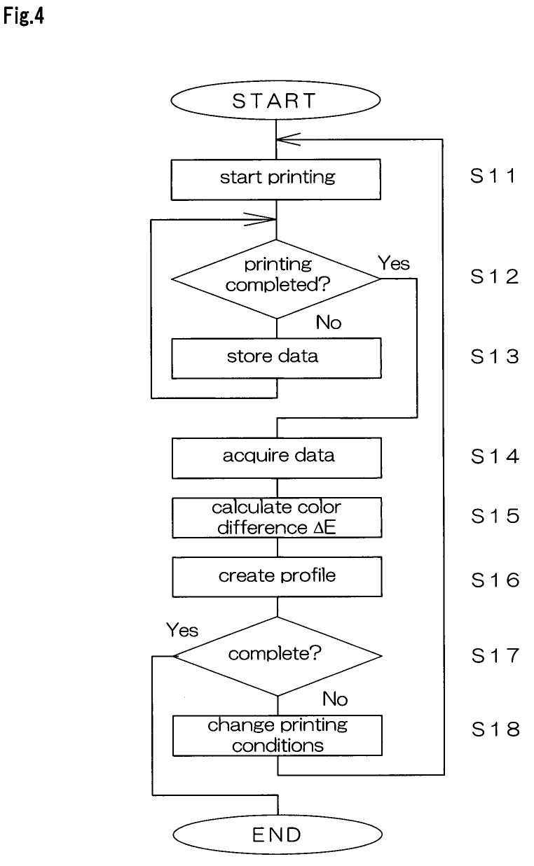

A profile creating process will be described first. FIG. 4 is a flow chart of the profile creating process.

Printing stability is changeable with various factors. The factors considered to influence printing stability include pattern area percentages in an image to be printed, and printing conditions (that is, conditions for an actual printing operation such as a printing machine used, the type of printing paper, the type of dot pattern and the type of ink). In the process of creating profile P, therefore, it is necessary to carry out test printing of an image having a plurality of different dot percentages, with different printing conditions about a printing machine, dot pattern, printing paper and ink. Thus, when collecting data first, a test image with gradually differing dot percentages is made available as the image having a plurality of dot percentages. The test image has dot percentages varying in units of 5% from 0% to 100%, for example.

In the profile creating process, printing is first performed using this test image (step S11). Until the printing is completed (step S12), the imaging unit 60 repeatedly measures data of control points on printed images. The measured data is stored in the RAM 82 of control unit 80 (step S13). The data measured at this time concerns color values and density values at control points on the image used for control of the feed rates of the ink and dampening water, and amounts of opening of ink keys of each ink feeder 20 corresponding to the control points.

When the printing is completed (step S12), the data stored in the RAM 82 is acquired (step S14). Histories of color difference ΔE and density difference are calculated from the color values and density values of the control points used as targets (step S15).

Next, from the history of color difference ΔE, information is obtained including the number of prints required from start of the printing until color difference ΔE is reduced to a predetermined range, the number of prints continuously made when color difference ΔE is 2 or less, the number of prints continuously made when color difference ΔE is 3 or less, and variations of color difference ΔE when the opening of the ink keys is constant. This information is written in the form of a look-up table in the RAM 82. From the history of density value, information is obtained including the number of prints continuously made when density difference is 0.05 or less, the number of prints continuously made when density difference is 0.1 or less, the number of prints required from start of the printing until a target density is attained, and variations of density when the opening of the ink keys is constant. This information is written in the form of a look-up table in the RAM 82. The profile P is created based on these look-up tables (step S16). That is, the profile P created corresponds to the printing conditions for printing the test image.

When the creation of profile P is continued, that is when creating a profile P corresponding to different printing conditions (step S17), the printing conditions are changed (Step S18). That is, the type of dot pattern, the type of printing paper and/or the type of ink are/is changed, and the above steps S11 through S16 are repeated. When profiles P corresponding to required printing conditions have been created (Step S17), the profile creating process is ended.

For changing the type of printing machine, among the printing conditions, the above operation is carried out using a different printing machine.

The type of dot pattern among the printing conditions concerns a selection from among AM (amplitude modulation) dots with a constant dot pitch such as of square, chain or round dots, FM (frequency modulation) dots in which unit dots are arranged at random and gradation is expressed by the number of unit dots per fixed area, and AM/FM hybrid dots having the characteristics of both AM and FM dots.

In the above profile creating process, data is first acquired from an image having a plurality of dot percentages. This image serves as a test image with dot percentages changing successively and gradually. However, the above profile creating process is performed also during an ordinary printing operation. At this time, data such as dot percentages of the image used for actual printing, the type of printing machine, the type of dot pattern, the type of printing paper, the type of ink and so on are stored in the form of a look-up table, and a profile is created by statistically processing data derived from the look-up table, such as color values, density values, color differences, density differences and so on.

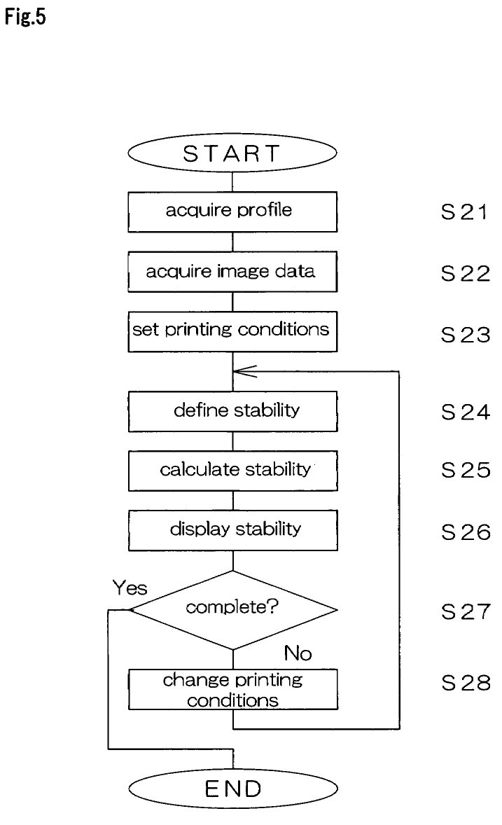

Next, stability calculating and displaying processes will be described. FIG. 5 is a flow chart of the stability calculating and displaying processes.

As shown in FIG. 3, the profile P obtained in the above profile creating process is inputted on-line or off-line, along with image data D to be printed, to the design application 100. Based on the profile P and image data D, the design application 100 calculates printing stability, and displays results on the control panel 101.

Specifically, the design application 100 first acquires profile P and image data D (steps S21 and S22). Next, the type of printing machine, the type of printing paper, the type of dot pattern and the type of ink constituting printing conditions for a next printing job are set by using the control panel 101 (Step S23).

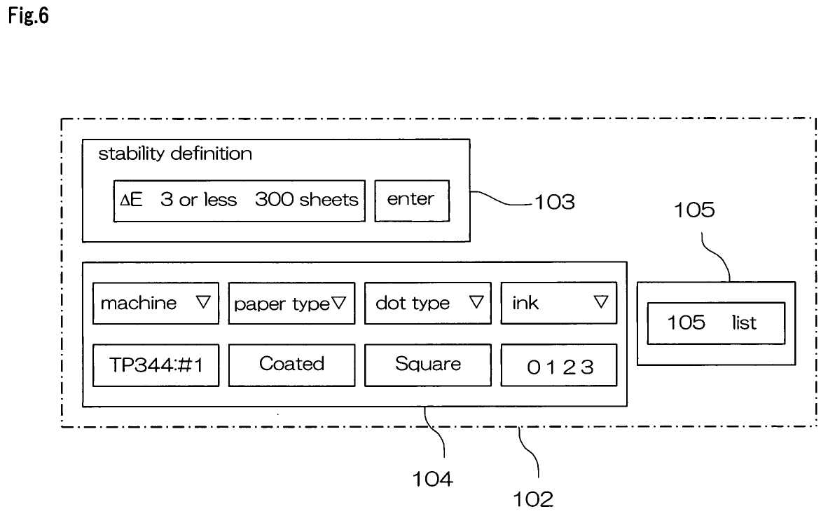

FIG. 6 is a schematic view showing a display screen 102 of the control panel 101.

This display screen shows an arrangement of a region 103 for inputting a definition of stability, a region 104 for inputting printing conditions, and a region 105 for listing printing conditions providing a large number of areas satisfying the defined stability.

First, the operator sets printing conditions by using the region 104 on this display screen.

In the illustrated example, No. 1 of Model TP344 printing machine is used as the type of printing machine, coated paper as the type of printing paper, square dots as the type of dot pattern, and ink of product No. 0123 as the type of ink. These options are selected from the types set beforehand.

Next, stability is defined (step S24). That is, conditions considered likely to provide a high degree of stability are defined by using the region 103 on the display screen. In the embodiment shown in FIG. 6, selected conditions are that color difference ΔE is 3 or less, and the number of prints made until color tones stabilize is 300 or less.

In this state, the design application 100 calculates stability based on the profile P and image data D acquired previously and the definition of stability (step S25).

Specifically, whether the conditions inputted as the definition of stability are fulfilled or not is determined for each area of the image to be printed. In this example, it is checked whether the number of prints required until color difference ΔE is reduced to 3 or less according to a dot percentage in each area of the image is 300 or less as defined. When the number of prints is 300 or less, stability is regarded as high. Otherwise, stability is regarded as low. The color difference ΔE may be regarded as being reduced to the designated range when, for example, a predetermined number of prints, e.g. 30 prints, made continuously show color difference ΔE at 3 or less. It is possible to use density difference instead of color difference for determining stability. Subsequently, a display of stability is made on the control panel 101 (Step S26).

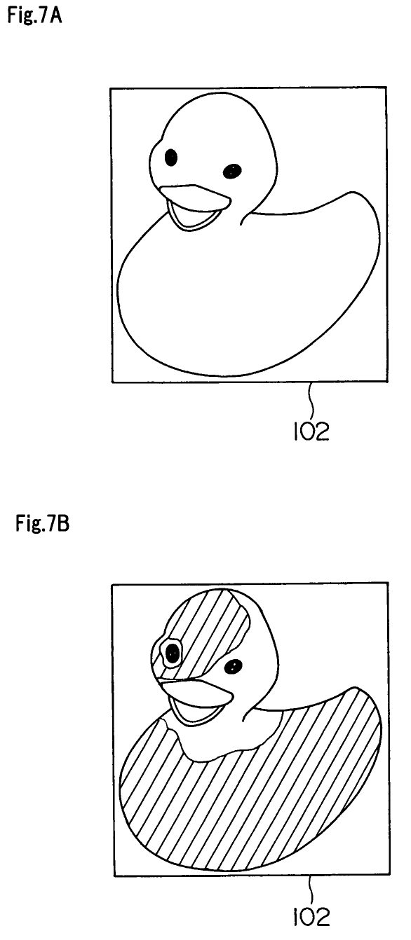

FIGS. 7A and 7B are schematic views showing states of stability displayed on the display screen 102 of control panel 101.

FIG. 7A shows a case of an entire print determined stable. On the other hand, when certain areas of the print are determined unstable, such areas are made to blink as shown in hatching in FIG. 7B.

Instead of blinking, the areas in question may be displayed in a different color. The display method may be varied according to the degree of stability. The display screen 102 for input shown in FIG. 6 and the display screen 102 for stability shown in FIG. 7 may be simultaneously displayed on the control panel 101.

For continuing the display of stability (step S27), the printing conditions are changed using the area 104 shown in FIG. 6 (step S28) and steps S24 through S26 are repeated. Subsequently, when a required display operation is completed (step S27), the stability displaying process is ended.

After changing the printing conditions in step S28, the operation returns to steps S24 to S26 for calculating and displaying stability again. The definition of stability may be changed, instead.

As another definition of stability, for example, a proportion of the number of prints having color tones fitting into a target range to a predetermined number of prints may be defined. As a specific example, the proportion of the number of prints with color difference ΔE being 2 or less to 1,000 prints may be defined as 80% or more. Of course, color difference may be replaced by density difference.

As a different definition of stability, a degree of color tone distribution on prints may be defined. As a specific example, a standard deviation may be obtained by statistically processing variations in the color value of prints, and the value of this standard deviation may be defined as the degree of stability. Two or more such definitions of stability may be combined for use.

In this case, the definition of printing conditions and stability is changed as appropriate and steps S24 through S26 are repeated. Then, after a required display operation is completed (step S27), the stability displaying process is ended.

After the printing conditions expected to provide a high degree of stability are confirmed in the stability displaying process as described above, an actual printing operation is carried out by referring to these printing conditions. As a result, the printing operation itself is performed with increased stability, with a prospect for a reduction in spoilage and a shortening of the time taken in color tone adjustment. This is useful also when making a man hour estimate for a printing operation beforehand.

In the above embodiment, low-stability areas of an image according to a definition of stability are displayed on the screen. The degree of stability may be displayed in a numerical representation of a proportion of areas not satisfying the definition of stability.

When the degree of stability is low, the calculating device may automatically change a combination of printing conditions, recalculate the degree of stability, and search for printing conditions that will provide increased stability. Then, printing conditions for increasing stability may be indicated by way of advice to the operator.

This invention may be embodied in other specific forms without departing from the spirit or essential attributes thereof and, accordingly, reference should be made to the appended claims, rather than to the foregoing specification, as indicating the scope of the invention.

This application claims priority benefit under 35 U.S.C. Section 119 of Japanese Patent Application No. 2006-056400 filed in the Japanese Patent Office on Mar. 2, 2006, the entire disclosure of which is incorporated herein by reference.

What is claimed is:

1. A stability display method comprising:
a printing step for setting a printing condition concerning at least one of a printing machine, a dot pattern, printing paper and ink, and printing an image having a plurality of different dot percentages with the printing condition set;
a profile creating step for creating a profile showing a degree of printing stability in form of a relationship between said printing condition and each of the dot percentages by measuring a print image obtained in said printing step;
a calculating step for deriving a degree of printing stability for each color area of an image to be printed, from image data of the image to be printed, the printing condition in time of printing and said profile; and
a displaying step for displaying the degree of printing stability of each color area, obtained in said calculating step, of the image to be printed.

2. A stability display method as defined in claim 1, wherein said image having a plurality of different dot percentages comprises an image with dot percentages changing successively and gradually.

3. A stability display method as defined in claim 1, wherein said degree of printing stability is a proportion of the number of prints having color tones fitting into a target range to a predetermined number of prints.

4. A stability display method as defined in claim 1, wherein said degree of printing stability is a degree of color tone distribution.

5. A stability display method as defined in claim 1, wherein said degree of printing stability is the number of prints made from start of printing until color tones stabilize.

6. A stability display method as defined in claim 1, wherein said degree of printing stability includes a proportion of the number of prints having color tones fitting into a target range to a predetermined number of prints, a degree of color tone distribution, and the number of prints made from start of printing until color tones stabilize.

7. A stability display method as defined in claim 1, wherein said displaying step for displaying the degree of printing stability displays areas on the image expected to have degrees of stability less than a predetermined degree.

8. A stability display method as defined in claim 1, wherein, after said displaying step, the printing condition in time of printing is changed and said calculating step and said display step are executed again.

9. A stability display method as defined in claim 1, wherein:
said printing step is executed to set a plurality of different printing conditions successively, and print the image having a plurality of different dot percentages with each of the printing conditions; and
said profile creating step is executed to create a profile capable of coping with each of said plurality of different printing conditions.

10. A stability display apparatus comprising:
a profile storage device for setting a printing condition concerning at least one of a printing machine, a dot pattern, printing paper and ink, and storing a profile showing a degree of printing stability determined in form of a relationship between said printing condition and each dot percentage by measuring an image with the printing condition set and having a plurality of different dot percentages;
a calculating device for deriving a degree of printing stability for each color area of an image to be printed, from image data of the image to be printed, the printing condition in time of printing and the profile stored in said profile storage device; and
a display device for displaying the degree of printing stability of each color area, calculated by said calculating device, of the image to be printed.
